(19) United States
(12) Patent Application Publication
(10) Pub. No.: US 2026/0302461 A1
(43) Pub. Date: Oct. 1, 2026

(54) FLUID CUSHION

(71) Applicant: HONDA MOTOR CO., LTD., Tokyo (JP)

(72) Inventors: Tatsuya SEKI, Saitama (JP); Hirokazu WATANABE, Saitama (JP); Hidemasa USUI, Saitama (JP)

(21) Appl. No.: 19/553,587

(22) Filed: Mar. 2, 2026

(30) Foreign Application Priority Data
Mar. 31, 2025 (JP) 2025-059998

(51) Int. Cl. H01M 50/204; H01M 10/613

(52) U.S. Cl. CPC H01M 50/204; H01M 10/613

(57) ABSTRACT

A fluid cushion that can fix a battery cell at a desired position is provided. A fluid cushion 20 is disposed between battery cells 10 that are stacked together. The fluid cushion 20 includes a cell positioner 70 configured to position the battery cells 10 that are adjacent to each other in a stack direction 1001.

This application is based on and claims priority under 35 U.S.C. §119 from Japanese Patent Application No. 2025-059998, filed on Mar. 31, 2025, the content of which is incorporated herein by reference.

### BACKGROUND OF THE INVENTION

### Field of the Invention

The present invention relates to a fluid cushion included in a battery module or the like.

### Related Art

In recent years, efforts for realizing a low carbon society or a decarbonized society have been activated, and research and development on battery modules has been conducted to reduce the CO₂ emissions and improve the energy efficiency also in vehicles. As for the battery module, for example, Japanese Unexamined Patent Application (Translation of PCT Application), Publication No. 2024-534977 discloses a technology of providing a fluid supply device between a plurality of stacked battery cells and another plurality of stacked battery cells.

Patent Document 1: Japanese Unexamined Patent Application (Translation of PCT Application), Publication No. 2024-534977

### SUMMARY OF THE INVENTION

Incidentally, the technology related to the battery module has a problem that it is difficult to fix the battery cells at desired positions.

To solve the problem described above, the present application has an object to provide a fluid cushion that can fix the battery cells at desired positions. This in turn contributes to improvement in energy efficiency.

(1) A fluid cushion according to the present invention is a fluid cushion disposed between battery cells stacked together in a stack direction, the fluid cushion including a cell positioner configured to position the battery, which are adjacent to each other in the stack direction, in at least one direction orthogonal to the stack direction.

According to such a fluid cushion, the battery cell can be fixed at a desired position. Specifically, by providing the portion for positioning the stacked battery cells and the fluid cushion on the fluid cushion side, the positioning can be maintained while controlling at least one selected from expansion and contraction of each battery cell, and expansion and contraction of the fluid cushion in a coordinated manner. While a fluid path with another fluid cushion is maintained, the energy density can be increased even with reduction in size of the battery module, and in turn, the battery module having a reduced size and a large capacity can be realized.

(2) The fluid cushion in the present invention may include a flange. The flange may include a concavity having a shape that matches a shape of an end of each of the battery cells as the cell positioner.

According to such a fluid cushion, the concavity allows secure positioning of the battery cell to be achieved with a simple configuration.

(3) The fluid cushion may include a cooling flow path. The flange may be provided at each of opposite ends of the cooling flow path, and the flange may further include a weld region at which the flange and the cooling flow path are fixed to each other by welding.

Such a fluid cushion can provide the fluid cushion that can fix the cooling flow path with a desired strength while preventing the battery module from increasing in size.

(4) In the fluid cushion, the weld region may have a strength that can absorb a peel load that occurs between the flange and the cooling flow path.

According to such a fluid cushion, by the load on each component caused by increasing the internal pressure of fluid, the flange and the cooling flow path can be prevented from being peeled off from each other.

(5) In the fluid cushion, the cooling flow path may be constituted of a fluid flow path, and the weld region of the flange may be formed of a material that is identical with or similar to a material of the fluid flow path.

Such a fluid cushion can make the weld region stronger. Accordingly, the flange and the fluid flow path can be further prevented from being peeled off from each other.

(6) In the fluid cushion, a separate cap-shaped member configured to cover the weld region and hold the welding between the flange and the cooling flow path may be provided.

Such a fluid cushion can reinforce the weld region, and further prevent the flange and the cooling flow path from being peeled off from each other.

(7) In the fluid cushion, an overmolded structure configured to cover the weld region and hold the welding between the flange and the cooling flow path may be provided.

Such a fluid cushion can reinforce the weld region, and further prevent the flange and the cooling flow path from being peeled off from each other.

(8) In the fluid cushion, an outer surface of the weld region of the flange may have a higher surface roughness than a surface of another portion of the flange.

Such a fluid cushion can further reinforce the welding at the weld region, and further prevent the flange and the cooling flow path from being peeled off from each other.

(9) In the fluid cushion, the cooling flow path may be configured such that a length of a portion that is continuous to the weld region and is not in contact with the battery cell is short.

Such a fluid cushion can prevent the cooling flow path from being broken by the internal pressure in the fluid path or the like.

According to such a battery module, the state of charge of the battery cell can be more correctly determined.

(10) A battery module includes: the fluid cushion; battery cells stacked with the fluid cushion interposed therebetween; a fluid tank that is coupled to the fluid cushion; a compressor that is coupled to the fluid tank; and a controller. The controller controls an operation of the compressor such that depending on at least one selected from expansion and contraction of the fluid cushion, pressure in the fluid cushion becomes a uniform pressure.

Such a battery module can maintain the surface pressure of the battery cell uniform. In particular, in the battery module that includes the stacked battery cells, the isobaricity of each battery cell can be easily maintained.

The present invention can provide the fluid cushion that can fix the cooling flow path with a desired strength while preventing the battery module from increasing in size.

### BRIEF DESCRIPTION OF THE DRAWINGS

FIG. 1 is a sectional view of a battery module in an embodiment of the present invention;

FIG. 2 is an enlarged diagram of a portion enclosed by a frame 1101 in FIG. 1;

FIG. 3 is a perspective view of a fluid cushion;

FIG. 4 is a sectional view taken along line 1200-1200 in FIG. 3;

FIG. 5 shows a manner where the fluid cushions and the battery cell are stacked;

FIG. 6 is a perspective view of the stacked fluid cushions;

FIG. 7 is a sectional view corresponding to a section taken along line 1210-1210 in FIG. 5;

FIG. 8 is a sectional view corresponding to FIG. 7 according to a conventional art;

FIG. 9 shows the fluid cushion and the battery cells shown in FIG. 6 in a direction along the stack direction;

FIG. 10 is a sectional view schematically showing the coupling between a fluid flow path and a flange;

FIG. 11 is a perspective view of the fluid cushion in one embodiment of the present invention;

FIG. 12 is a perspective view of the flange;

FIG. 13 is a sectional view schematically showing the coupling between the fluid flow paths and the flanges where the sectional view shown in FIG. 10 is modeled, and the number of layers of the battery cells and the fluid cushions are increased;

FIG. 14 is a sectional view showing a modified example where the material of the example in FIG. 13 is changed, and schematically showing the coupling between the fluid flow paths and the flanges;

FIG. 15 is a sectional view showing a modified example where holders are added to the example shown in FIG. 13, and schematically showing the coupling between the fluid flow paths and the flanges;

FIG. 16 is a sectional view corresponding to a section taken along line 1222-1222 in FIG. 17, and showing a modified example where a welding holder is added to the example shown in FIG. 13;

FIG. 17 shows the fluid cushion to which the welding holder is added when viewed from the stack direction;

FIG. 18 shows an example where the flanges are stacked;

FIG. 19 is an exploded perspective view of a power unit;

FIG. 20 shows the flow of fluid between the power unit and a vehicle body;

FIG. 21 shows a power unit and the like further provided with a pressure-sensitive sensor;

FIG. 22 shows a vehicle body and the like further provided with a tank sensor;

FIG. 23 shows a power unit and the like further provided with a water jacket;

FIG. 24 shows a power unit and the like where the water jacket is omitted; and

FIG. 25 schematically shows an example of a cooling system of the vehicle.

### DETAILED DESCRIPTION OF THE INVENTION

### Battery Module

Embodiments for implementing the present invention will be described with reference to the drawings. Note that the after-mentioned embodiments are for the description of the present invention as examples. The present invention is not limited to the contents described below.

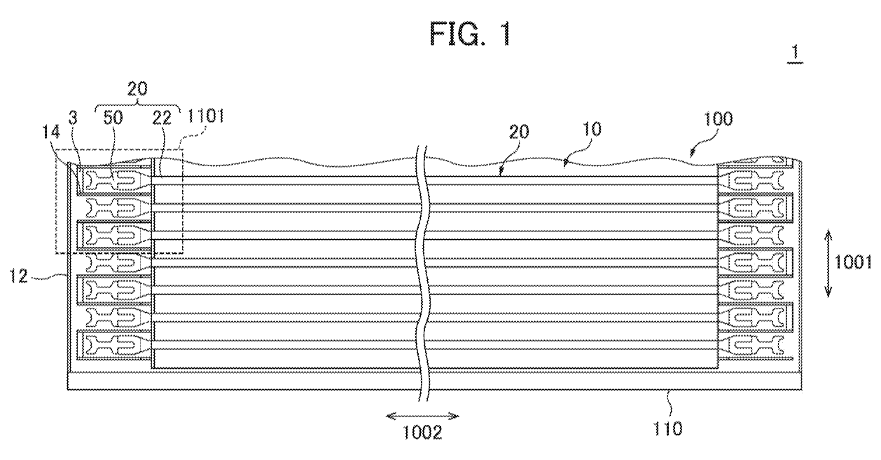

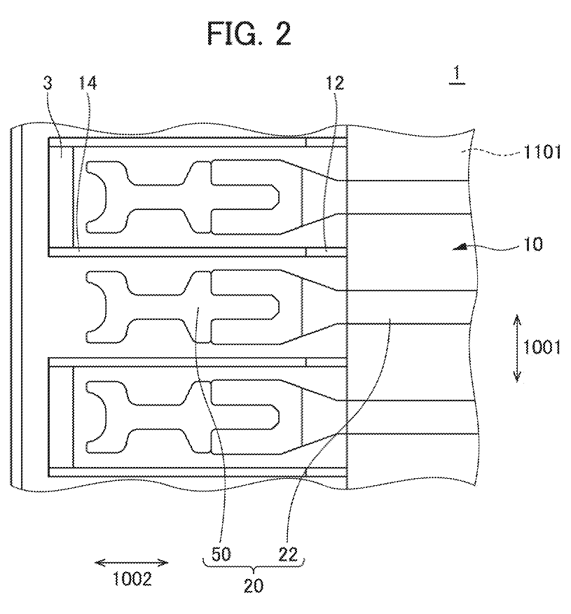

FIG. 1 is a sectional view of a battery module 1 in an embodiment of the present invention. FIG. 2 is an enlarged diagram of a frame 1101 in FIG. 1. As shown in FIGS. 1 and 2, the battery module 1 includes a battery cell stack 100 and an endplate 110.

The battery cell stack 100 includes battery cells 10, and fluid cushions 20. Multiple layers of the battery cells 10 are stacked in the battery cell stack 100. A direction in which the battery cells 10 are stacked is called a stack direction 1001. Each fluid cushion 20 is disposed between the battery cell 10 and the battery cell 10 that are stacked together.

The endplates 110 are disposed at the opposite ends of the battery cell stack 100 in the stack direction 1001. FIG. 1 only shows the endplate 110 disposed at one end of the battery cell stack 100.

FIG. 1 shows a fluid path direction 1002. The fluid path direction 1002 is a direction along a direction in which fluid flows in the fluid cushions 20. The fluid path direction 1002 is orthogonal to the stack direction 1001.

As shown in FIGS. 1 and 2, each fluid cushion 20 includes a fluid flow path 22 and flanges 50. The fluid flow path 22 is one form of a cooling flow path. The flanges 50 are provided at the opposite ends of the fluid flow path 22 in the fluid path direction 1002.

The flanges 50 are stacked in the stack direction 1001 at the opposite ends of the battery cell stack 100 in the fluid path direction 1002.

The battery cells 10 include cell terminals 12 and tab leads 14. The cell terminals 12 and the tab leads 14 are provided at the opposite ends in the fluid path direction 1002. The cell terminals 12 are extracted on the opposite sides of the battery cell stack 100 in the fluid path direction 1002 from between the stacked flanges 50. The tab lead 14 is formed to be continuous to the cell terminal 12. The battery cell 10 is coupled to a bus-bar 3 via the tab lead 14.

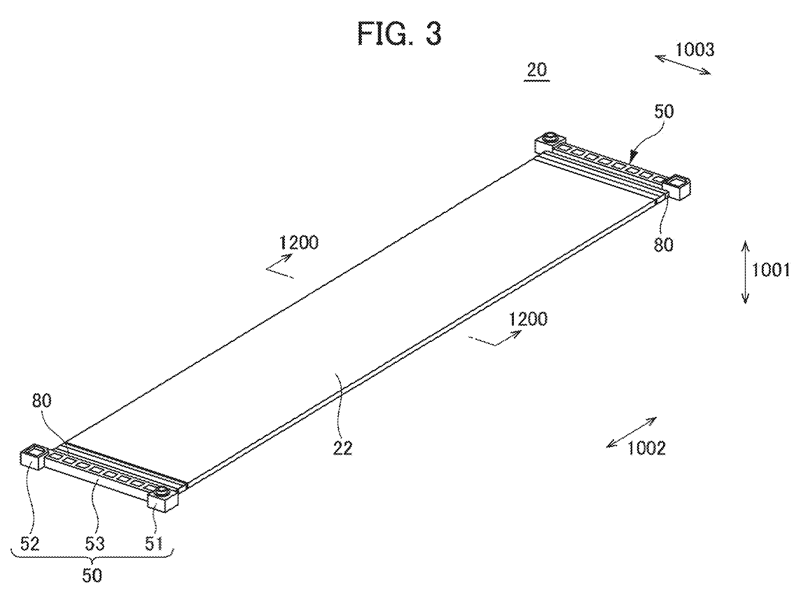

Referring to FIG. 3, the fluid cushion 20 is described. FIG. 3 is a perspective view of the fluid cushion 20. FIG. 3 shows one of the fluid cushions 20 included in the battery cell stack 100. A direction orthogonal to the stack direction 1001 and the fluid path direction 1002 is called a width direction 1003.

The shape of the fluid flow path 22 is a rectangular shape when viewed along the stack direction 1001. In the fluid flow path 22, in a section in the width direction 1003, a space which serves as a fluid path and through which the fluid flows is formed. Flanges 50 are provided at the opposite ends of the fluid flow path 22 in the fluid path direction 1002. The flanges 50 are formed to cover the entire areas, in the width direction 1003, of the respective ends of the fluid flow path 22 in the fluid path direction 1002.

The fluid flow path 22 may be constituted of a stack of resin or metal, for example. An example of the stack is a stack of polypropylene-aluminum-polypropylene.

The flange 50 may be a molded object made of resin, for example. An example of the resin of which the flange 50 is made is polypropylene.

A portion at which the fluid flow path 22 and the flange 50 are fixed to each other is called a joint portion. In the present embodiment, the fluid flow path 22 and the flange 50 are fixed by welding. A portion at which the fluid flow path 22 and the flange 50 are welded together is called a weld region 80. The weld region 80 is a form of the joint portion.

When the fluid flow path 22 and the flange 50 are welded, the welding may be, for example, hot-melt welding. Note that the type of welding is not limited to hot-melt welding. The welding may be high-frequency welding, ultrasonic welding, or laser welding. The fixation between the fluid flow path 22 and the flange 50 is described later.

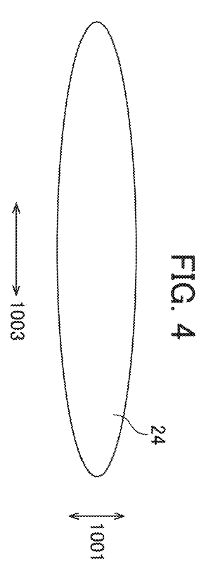

The fluid flow path 22 is constituted of a laminate 24. FIG. 4 is a sectional view taken along line 1200-1200 in FIG. 3.

A portion that defines the external shape of the fluid flow path 22 is called the laminate 24. The laminate 24 has an enclosed shape on a section taken along line 1200-1200. A hollow portion surrounded by the laminate 24 serves as a fluid path. The fluid flows through each fluid path.

Through each fluid flow path 22, the fluid flows along the fluid path direction 1002 from one end to the other end in the fluid path direction 1002.

### Function of Fluid Cushion

The volumes of the battery cells 10 change depending on the charge and discharge of the battery cells 10. The fluid flow paths 22 have a function of accommodating the volumes of the battery cells 10. For example, when the battery cells 10 are charged and expanded, the filling amount of fluid flowing through the fluid paths is reduced. When the filling amount decreases, the sectional areas of the fluid paths decrease. Accordingly, the fluid flow paths 22 accommodate the increase in volume of the battery cells 10.

On the other hand, when the battery cells 10 are discharged and contracted, the filling amount of the fluid flowing through the fluid paths is increased. When the filling amount increases, the sectional areas of the hollow portions surrounded by the laminates 24 increase. Accordingly, the fluid flow paths 22 accommodate the reduction in volume of the battery cells 10. Thus, the fluid flow paths 22 accommodate the pulsation in volume of the battery cells 10, and the volume of the battery cell stack 100 tends to be maintained constant.

The fluid flow path 22 is provided between each pair of the battery cell 10 and the battery cell 10. Accordingly, the fluid flow paths 22 accommodate the expansion and contraction of the battery cells 10 in a coordinated manner.

The fluid cushions 20 can cool the battery cells 10. The temperature of the battery cells 10 increases during charging. By allowing the fluid to flow through the fluid cushions 20, heat exchange between the battery cells 10 and the fluid can occur. As a result of the heat exchange, the temperature of the battery cells 10 can decrease.

### Configuration of Flange

Referring to FIG. 3, the configuration of each flange 50 is described. As shown in FIG. 3, each flange 50 includes a flange extension 53, a first stacking part 51, and a second stacking part 52. The first stacking part 51 is provided at one end of the flange extension 53 in the width direction 1003. The second stacking part 52 is provided at the other end of the flange extension 53 in the width direction 1003.

The flange extension 53 is a portion that covers almost all the corresponding end of the fluid flow path 22 in the fluid path direction 1002. The flange extension 53 has a shape elongated in the width direction 1003.

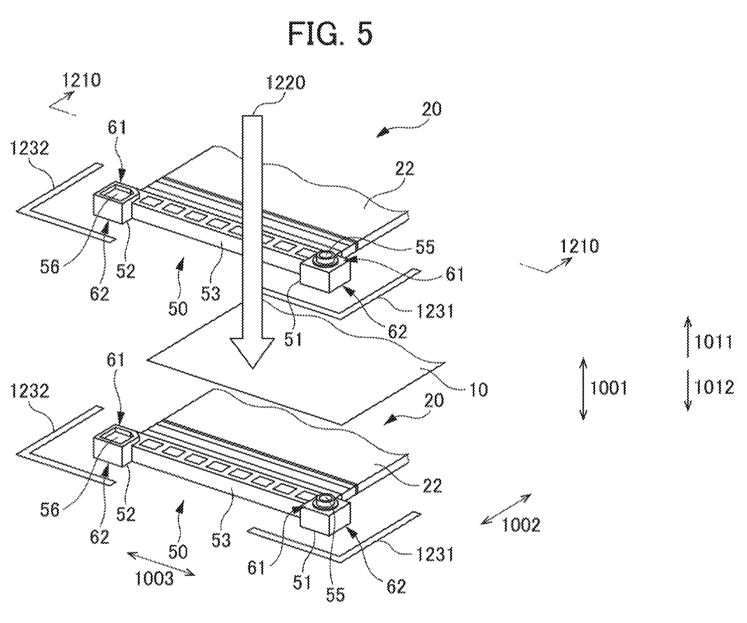

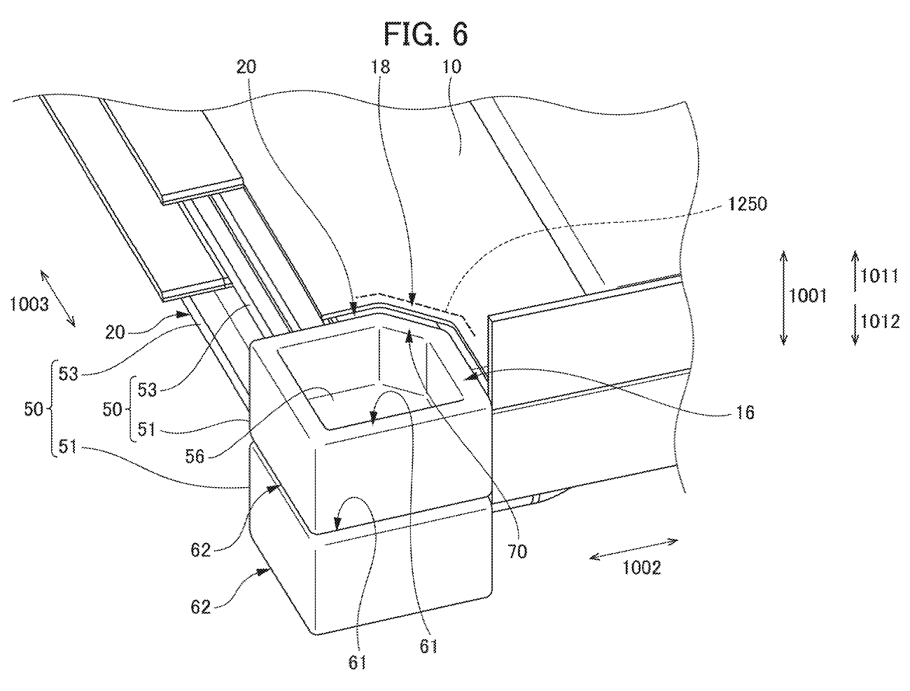

The first stacking part 51 and the second stacking part 52 are portions with which the fluid cushions 20 adjacent in the stack direction 1001 are in contact when the fluid cushions 20 are stacked. Referring to FIGS. 5 and 6, the stacking parts are described.

FIG. 5 shows a manner where the fluid cushions 20 and the battery cell 10 are stacked. FIG. 6 is a perspective view of the stacked fluid cushions 20. FIGS. 5 and 6 show parts of the fluid cushions 20 and the battery cells 10.

FIG. 5 shows a stacking direction 1220. The stacking direction 1220 is a stacking direction in a case of sequentially stacking each fluid cushion 20 and each battery cell 10. The stacking direction 1220 is parallel to the stack direction 1001.

FIG. 5 indicates an upward direction 1011 and a downward direction 1012. The upward direction 1011 and the downward direction 1012 are in parallel to the stack direction 1001. The upward direction 1011 and the downward direction 1012 indicate the opposite directional senses. Upward and downward in the following description are based on the upward direction 1011 and the downward direction 1012, respectively.

The two fluid cushions 20 are stacked in the direction indicated by the stacking direction 1220 in a state of interposing the battery cell 10 therebetween. The two fluid cushions 20 are stacked such that their first stacking parts 51 can be stacked in the stack direction 1001, and their second stacking parts 52 can be stacked in the stack direction 1001.

In the example shown in FIG. 5, a fitting convexity 55 is provided on an upper surface 61 of the first stacking part 51. A fitting concavity, not shown, is provided in a lower surface 62 of the first stacking part 51. It is configured such that when the two first stacking parts 51 are stacked, the fitting convexity 55 on the upper surface 61 of the first stacking part 51 positioned on the lower side is fitted into the fitting concavity in the lower surface 62 of the first stacking part 51 positioned on the upper side.

A fitting concavity 56 is provided in the upper surface 61 of the second stacking part 52. A fitting convexity, not shown, is provided on the lower surface 62 of the second stacking part 52. It is configured such that when the two second stacking parts 52 are stacked, the fitting convexity on the lower surface 62 of the second stacking part 52 positioned on the upper side is fitted into the fitting concavity 56 in the upper surface 61 of the second stacking part 52 positioned on the lower side.

By stacking the fluid cushions 20 such that the first stacking parts 51 can be fitted together, and the second stacking parts 52 can be fitted together, the fluid cushions 20 can be stacked at correct positions with no positional deviation.

FIG. 6 shows the manner where the first stacking parts 51 are fitted together and stacked. Note that the example shown in FIG. 6 has an inverted upper and lower relationship between the fitting concavity and the fitting convexity with respect to the example shown in FIG. 5. In the example shown in FIG. 6, in a manner inverted to the example in FIG. 5, the fitting concavity 56 is provided in the upper surface 61 of the first stacking part 51, and the fitting convexity, not shown, is provided on the lower surface 62 of the first stacking part 51. As shown in FIG. 6, the first stacking parts 51 are stacked such that the fitting convexity is fitted with the fitting concavity 56, thereby allowing the fluid cushions 20 to be stacked at correct positions.

Note that an O-ring, not shown, may be provided between the stacked first stacking part 51 and first stacking part 51 and between the stacked second stacking part 52 and second stacking part 52.

### Positional Deviation Between Fluid Flow Path and Battery Cell

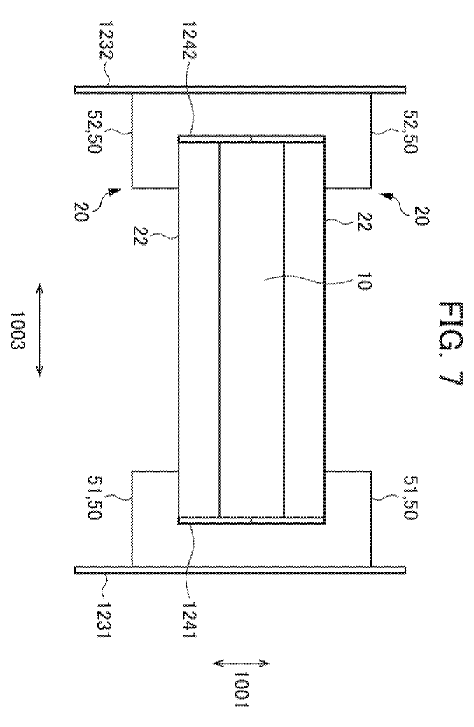

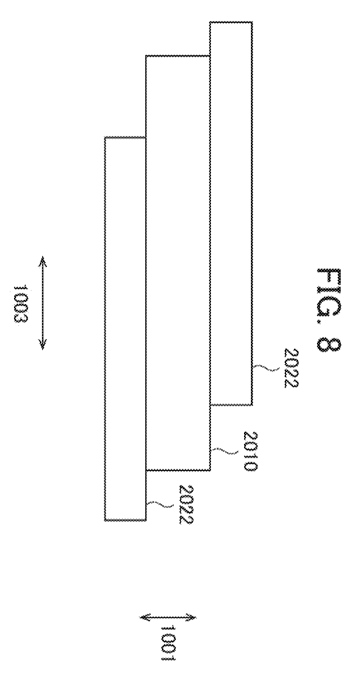

The positional deviation between the fluid flow path 22 and the battery cells 10 is described. FIG. 7 is a sectional view of the fluid flow path 22 and the like corresponding to a section taken along line 1210-1210 in FIG. 5. FIG. 8 is a sectional view of the fluid flow path 22 and the like corresponding to FIG. 7. FIGS. 7 and 8 show sections where the fluid flow path and the battery cells are stacked.

FIGS. 5 and 7 show first positioning lines 1231 and second positioning lines 1232. Each first positioning line 1231 is a line that indicates the position of an end of the first stacking part 51 in the width direction 1003. Each second positioning line 1232 is a line that indicates the position of an end of the second stacking part 52 in the width direction 1003.

FIG. 7 shows a first fluid flow path end line 1241 and a second fluid flow path end line 1242. The first fluid flow path end line 1241 and the second fluid flow path end line 1242 are lines that indicate the positions of ends of the fluid flow paths 22 in the width direction 1003.

As described with reference to FIG. 6 and the like, the first stacking parts 51 are stacked together and the second stacking parts 52 are stacked together, at the respective correct positions with no positional deviation. Accordingly, as shown in FIG. 7, the ends of the two stacked flanges 50 are aligned on the first positioning line 1231 and the second positioning line 1232.

In each fluid cushion 20 in the present embodiment, the fluid flow paths 22 are preliminarily fixed to the flanges 50. Accordingly, the alignment of the positions of the flanges 50, in turn, aligns the positions of the fluid flow path 22. As shown in FIG. 7, the ends of the two stacked fluid flow paths 22 are aligned with the first fluid flow path end line 1241 and the second fluid flow path end line 1242.

Accordingly, pressure can be correctly applied, without positional deviation, to the range on the battery cell 10 where the pressure is intended to be applied. As a result, a desired battery performance can be achieved.

In contrast, according to the conventional art, the fluid cushion includes no flange. Accordingly, as shown in FIG. 8, the positions of the ends of the stacked fluid flow paths 22 are not aligned. Accordingly, the pressure application position on the battery cell 10 deviates from a desired position. As a result, the desired battery performance cannot be achieved.

### Positioning of Battery Cell

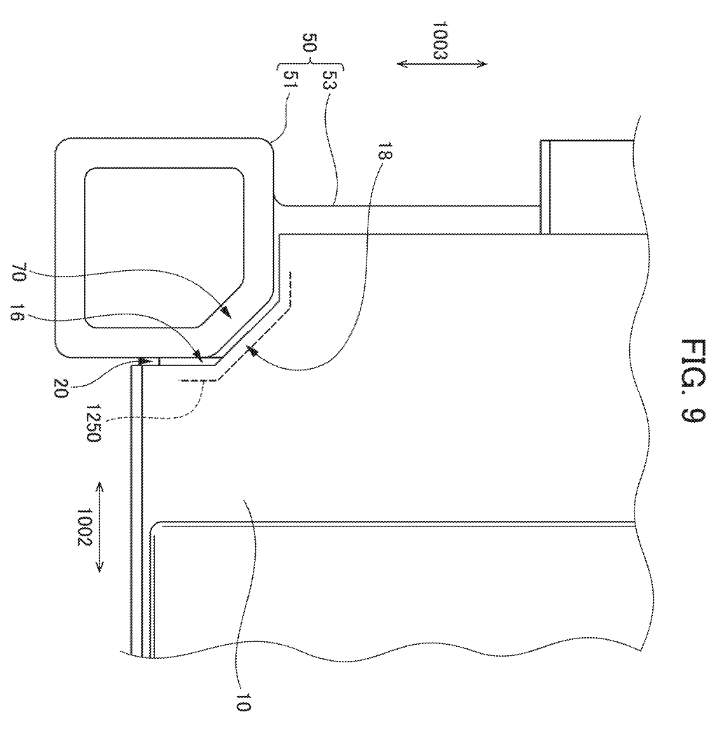

Referring to FIGS. 6 and 9, the positioning of the battery cell 10 is described. FIG. 9 shows the fluid cushions 20, the battery cells 10 and the like shown in FIG. 6 when viewed along the stack direction 1001. The fluid cushions 20 in the present embodiment are provided with cell positioners 70 that position the battery cells 10 adjacent to each other in the stack direction 1001. Specifically, the cell positioner 70 is provided at each flange 50 of each fluid cushion 20. More specifically, the cell positioners 70 are provided at the stacking parts of the flanges 50. The cell positioner 70 is described below with the first stacking part 51 as an example. The description below similarly applies to the second stacking part 52.

### Cell Positioner

As shown in FIGS. 6 and 9, the shape of the first stacking part 51 is a substantially rectangular shape when viewed along the stack direction 1001. The first stacking part 51 has a shape where one corner of a quadrilateral shape is cut out when viewed along the stack direction 1001. In other words, the first stacking part 51 has a shape that has a step formed by cutting out the corner.

The portion where the corner is cut out from the first stacking part 51 is called a concavity. In the example shown in FIGS. 6 and 9, the cell positioner 70 is the concavity.

### End of Battery Cell

Referring to FIGS. 6 and 9, the shape of the end of the battery cell 10 is described. The end of the battery cell 10 is called a cell end 16. The portion of the cell end 16 that corresponds to the cell positioner 70 of the flange 50 has a shape that matches the cell positioner 70. In other words, the shape of the cell positioner 70 of the flange 50 is a shape that matches the shape of the cell end 16.

The portion of the cell end 16 that corresponds to the cell positioner 70 of the flange 50 is provided with a positioning portion 18. In the example shown in FIGS. 6 and 9, the positioning portion 18 is a portion at which the corner of the battery cell 10 is cut out. The positioning portion 18 has a shape that matches the cell positioner 70 when viewed along the stack direction 1001.

Note that the form where the cell positioner 70 and the positioning portion 18 have shapes matching each other does not only mean a form where the shape of the cell positioner 70 and the shape of the positioning portion 18 coincide with each other when viewed along the stack direction 1001.

FIGS. 6 and 9 show a positioning shape line 1250. The positioning shape line 1250 is a line that indicates the approximate shape of the positioning portion 18. The state where the cell positioner 70 and the positioning portion 18 have shapes that match each other means a state where the shape of the cell positioner 70 has a shape that is identical with or similar to that of the positioning shape line 1250.

In the battery module 1 in the present embodiment, the fluid cushions 20 include the cell positioners 70, thereby allowing the battery cells 10 to be correctly positioned. When the fluid cushions 20 and the battery cells 10 are stacked, they are stacked so as to engage the cell positioner 70 and the positioning portion 18 with each other. Such stacking can correctly position the battery cells 10 in the fluid path direction 1002 and the width direction 1003.

According to the battery module 1 in the present embodiment, for example, even in a case where many battery cells 10, the number of which is about thirty, for example, are stacked, the battery cells 10 can be correctly positioned.

The dimensions of the battery cells 10 change depending on charge and discharge of the battery cells 10. That is, the dimensions of the battery cells 10 pulsate. According to the battery module 1 in the present embodiment, even when the dimensions of the battery cells 10 pulsate, the positional deviation of the battery cells 10 is prevented, and the battery cells 10 can be positioned at correct positions.

Note that the concavity shape of the cell positioner 70 shown in FIGS. 6 and 9 is shown as an example. The shape of the cell positioner 70 is not limited to the shape with the corner being cut out. The concavity shape may be another shape. The shape of the cell positioner 70 is not limited to the concavity. The shape of the cell positioner 70 may be a convexity, or a concave and convex type where a concavity and a convexity are combined.

The cell positioner 70 is not limited to the configuration where part of each flange 50 is cut out, and concavities or convexities are formed at the flange 50 when viewed along the stack direction 1001. Each cell positioner 70 may be, for example, a cutout or the like that is formed at the flange 50, in particular, the stacking part, and extends in at least one selected from the fluid path direction 1002 and the width direction 1003. In the case where the cell positioners 70 are cutouts, the battery cells 10 can be correctly positioned by inserting the cell ends 16 into the corresponding cutouts.

Note that each cell positioner 70 may be provided such that at the cell positioner 70, a gap may be provided between the cell end 16 and the flange 50 in at least one selected from the fluid path direction 1002 and the width direction 1003. Even when the dimensions of the battery cells 10 change depending on charge and discharge, the formation of the gap can appropriately maintain the stack state between the battery cells 10 and the fluid cushions 20.

### Coupling Between Fluid Flow Path and Flange

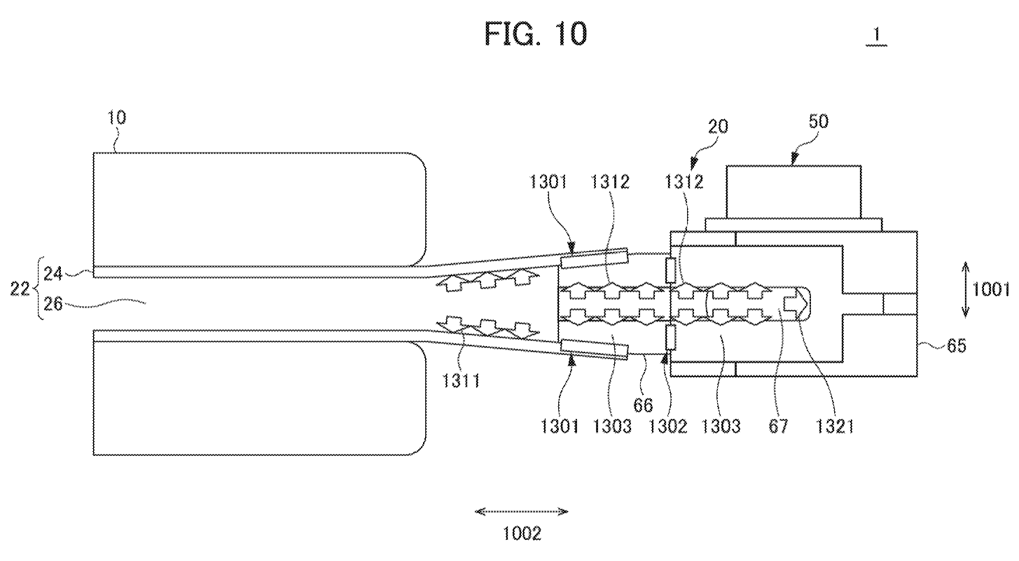

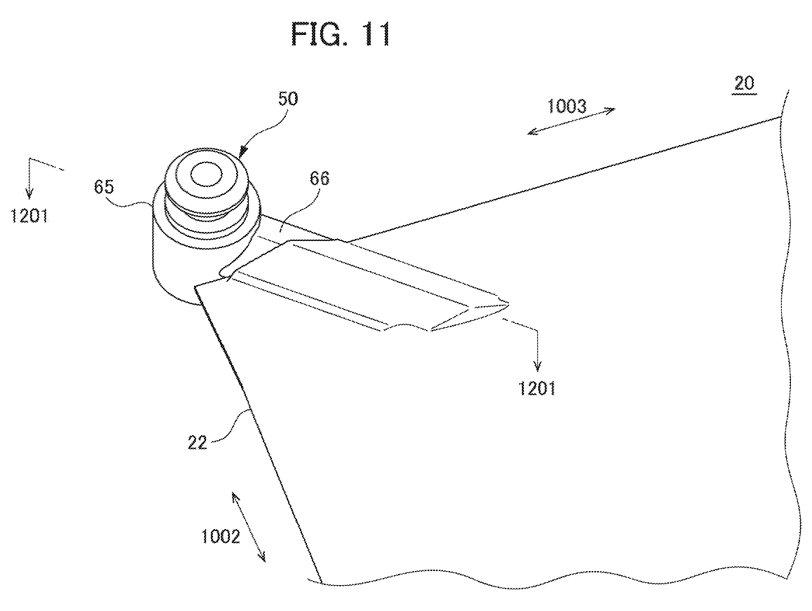

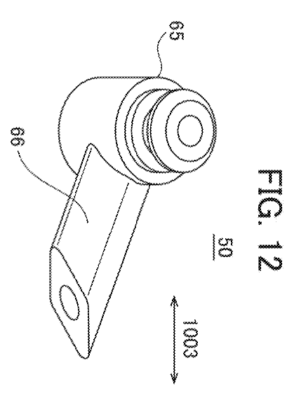

The coupling between the fluid flow path 22 and the flange 50 is described. FIG. 10 is a sectional view schematically showing the coupling between the fluid flow path 22 and the flange 50. FIG. 11 is a perspective view of the fluid cushion 20 in one embodiment of the present invention. FIG. 12 is a perspective view of the flange 50. FIG. 12 shows the flange 50 before the fluid flow path 22 is coupled. By coupling the fluid flow path 22 to the flange 50 shown in FIG. 12, the fluid cushion 20 shown in FIG. 11 is formed.

FIG. 10 corresponds to a sectional view taken along line 1201-1201 in FIG. 11. Note that unlike FIG. 11, FIG. 10 depicts the battery cells 10 on the opposite ends of the fluid flow path 22 in the stack direction 1001.

Note that the fluid cushion 20 shown in FIG. 11 has a configuration partially different from that of the fluid cushion 20 previously shown in FIG. 3 and the like. The coupling between the fluid flow path 22 and the flange 50 is focused and described below. Note that the fluid cushions 20 in the present invention also encompass the fluid cushions 20 that have both the configuration of the fluid cushion 20 shown in FIG. 11, and the configuration of the fluid cushion 20 shown in FIG. 3.

Referring to FIG. 10, forces applied to the fluid flow path 22 and the flange 50 are described. The battery cells 10 have dimensions that change depending on charge and discharge. The battery cells 10 have temperatures that change depending on charge and discharge. The fluid flow path 22 is interposed between the battery cells 10. Accordingly, various forces are applied to the fluid flow path 22. The flange 50 is coupled to the fluid flow path 22. Accordingly, various forces are also applied to the flange 50.

The configuration of the flange 50 shown in FIG. 10 is described. The flange 50 includes a flange main body 65 and a flange connection 66. The flange connection 66 is a portion that protrudes from the flange main body 65 toward the fluid flow path 22 so as to facilitate the coupling between the flange 50 and the fluid flow path 22. The fluid flow path 22 is coupled to the flange 50 at the flange connection 66. The flange connection 66 has a cylindrical shape. A flange flow path 67 for allowing the fluid to flow therethrough is formed in the flange 50. The flange flow path 67 is formed through the flange connection 66 and the flange main body 65.

FIG. 10 shows a coupling region 1301, a boundary region 1302, and a fluid path region 1303. The coupling region 1301 is a region where the fluid flow path 22 is coupled to the flange 50. The coupling region 1301 corresponds to the weld region 80. The boundary region 1302 is a region at the boundary between the flange main body 65 and the flange connection 66. The flow path region 1303 is a region of an inner wall of the flange flow path 67.

A load applied to the fluid cushion 20 is described. By applying the internal pressure to the fluid, specifically, by applying pressure to the cell through the internal pressure, a load mainly occurs. Another factor of the load is a load affected by heat expansion described below. By applying pressure to the fluid in the fluid flow path 22, a force in a direction of expanding the fluid path is applied to the fluid flow path 22. This force is called a peeling force 1311. The application of the peeling force 1311 to the coupling region 1301 causes peeling between the laminate 24 and the flange connection 66.

A force applied to the boundary region 1302 is described. For example, in a case where the materials of the flange main body 65 and the flange connection 66 differ from each other, a force of peeling the flange main body 65 and the flange connection 66 from each other is applied to the boundary region 1302. In the case where the heat expansion coefficient of the material of the flange main body 65 differs from the heat expansion coefficient of the material of the flange connection 66, the change in temperature of the boundary region 1302 causes a force due to the difference in heat expansion coefficient to be applied to the boundary region 1302. This force causes peeling between the flange main body 65 and the flange connection 66.

A force applied in a shear direction, i.e., a shear force, occurs in the boundary region 1302. This shear force also causes peeling between the flange main body 65 and the flange connection 66.

A force applied to the flow path region 1303 is described. A force that tends to deform the flange flow path 67 in an expanding direction is applied to the flow path region 1303. This force is called a deformation force 1312. The deformation force 1312 is caused by the pressure during the fluid flowing through the flange flow path 67, and by the motion of the fluid. The deformation force 1312 serves as a cause of deforming the flange flow path 67.

As described above, depending on the change in temperature, pressure and the like, the peeling force and the shear force are applied to the portion at which the fluid flow path 22 and the flange 50 are coupled to each other. These forces possibly affect the reliability and the durability of the portion at which the fluid flow path 22 and the flange 50 are coupled to each other. Accordingly, it is important to consider them in a design stage.

As for the coupling reliability between the fluid flow path 22 and the flange 50, in particular, there is a problem of the peeling force caused by the fluid path internal pressure in the fluid flow path 22 and the flange 50.

Each battery cell 10 has a temperature that changes depending on charge and discharge. The change in temperature, in turn, changes the temperatures of the fluid flow path 22 and the flange 50. Here, typically, the fluid flow path 22 and the flange 50 have different heat expansion coefficients.

As described above, the fluid flow path 22 is, for example, a stack made of a resin layer and a metal layer that are stacked together. The fluid flow path 22 is formed to be capable of expanding and contracting.

On the other hand, the flange 50 is made of, for example, resin, and is formed to be rigid. Unlike the fluid flow path 22, the flange 50 is formed to have minimal dimensional change.

Since the fluid flow path 22 and the flange 50 have different physical properties, it is important to secure the coupling reliability between the fluid flow path 22 and the flange 50.

Incidentally, a requirement for the battery module 1 is that the size is small. For example, each component included in the battery module 1 has, for example, a scale of several millimeters in some cases. Accordingly, even though the coupling between the fluid flow path 22 and the flange connection 66 in the coupling region 1301 is intended to be strengthened, fixation using a screw or the like is impossible. The coupling between the fluid flow path 22 and the flange connection 66 is required to be established while achieving compactness without bulkiness. In view of preventing the fluid flow path 22 and the flange connection 66 from being peeled off from each other, the configuration and the like of a portion at which the fluid flow path 22 is coupled to the flange connection 66 are described below.

### Weld Region

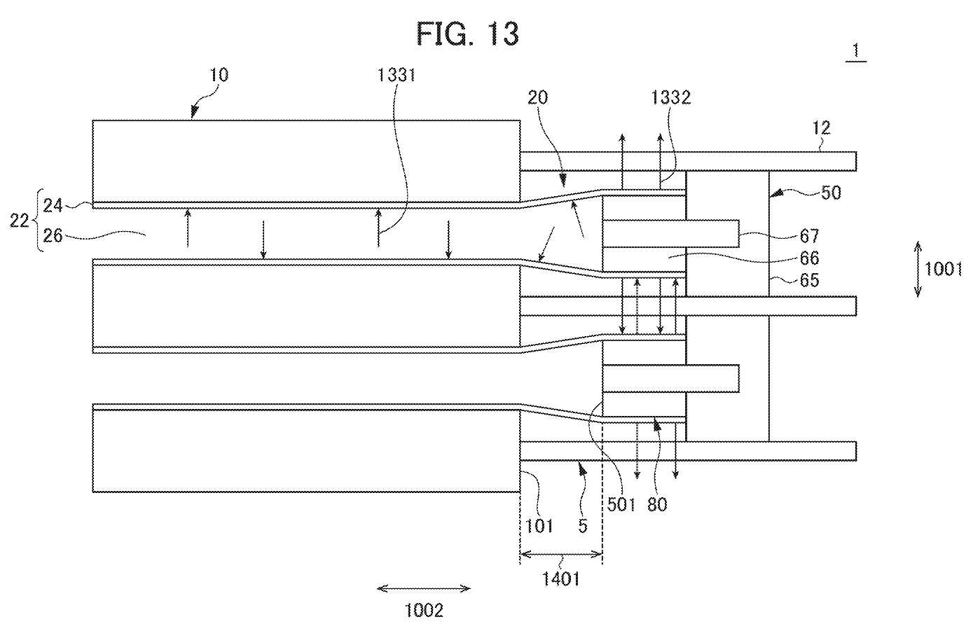

FIG. 13 is a sectional view schematically showing the coupling between the fluid flow paths 22 and the flanges 50 where the sectional view shown in FIG. 10 is modeled, and the number of layers of the battery cells 10 and the fluid cushions 20 are increased. A main factor of peeling between the fluid flow path 22 and the flange 50 is the internal pressure in the fluid path 26 as described above. FIG. 13 shows peel loads 1332. The peel loads 1332 are loads applied to portions at which the laminates 24 and the flange connections 66 are coupled. Each peel load 1332 is applied in a direction in which the laminate 24 and the flange connection 66 are peeled off from each other. The peel load 1332 is caused mainly by the pressure in the fluid flow path 22.

Preferably, the coupling between the laminate 24 and the flange connection 66 has a strength that can absorb the peel load 1332. In the battery module 1 in the present embodiment, the laminate 24 and the flange connection 66 are coupled to each other by welding, and are fixed. A portion at which the laminate 24 and the flange connection 66 are coupled to each other by welding and fixed is called a weld region 80. That is, the battery module 1 in the present embodiment includes the weld region 80. The weld region 80 has a strength that can absorb the peel load 1332.

The weld region 80 is formed by welding a portion of the laminate 24 that is in contact with the flange connection 66 and a portion of the flange connection 66 that is in contact with the laminate 24. Accordingly, at least part of the weld region 80 is part of the laminate 24, and at least other part of the weld region 80 is part of the flange connection 66. In other words, the weld region 80 includes the weld region 80 as part of the laminate 24, and the weld region 80 as part of the flange connection 66.

The battery module 1 in the present embodiment is provided with the weld regions 80, thereby allowing the coupling strength between the fluid flow path 22 and the flange 50 to be secured. The weld region 80 is resistant to increase in size in comparison with other fixing means, such as a screw, for example. Accordingly, by providing the weld region 80, requirements for the battery module 1, such as reduction in size and thickness, are easily satisfied. Consequently, even if the battery module 1 is reduced in size, the energy density can be increased. Accordingly, the battery module 1 that has a small size and a large capacity can be realized.

To improve the strength of the weld region 80, a configuration where the material of the laminate 24 is the same as the material of the flange connection 66 is conceivable. Even in a case where the material of the laminate 24 is not the same as the material of the flange connection 66, the laminate 24 and the flange connection 66 can be welded together. Note that in a case where the material of the laminate 24 is the same as the material of the flange connection 66, the strength of the weld region 80 can be further improved. As described above, the laminate 24 may be, for example, a stack of polypropylene-aluminum-polypropylene. A configuration where the material of the flange connection 66 is polypropylene can further improve the strength of the weld region 80.

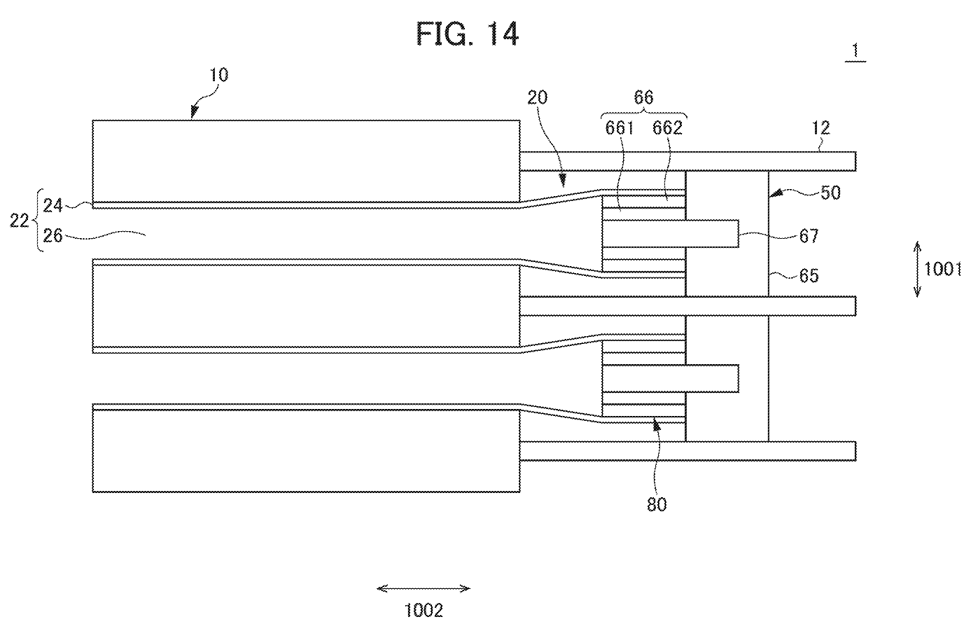

Note that typically, polypropylene has a low material strength. In a case where the flange connection 66 and the entire flange 50 are formed of polypropylene, there is a concern that the flange 50 is broken by a fluid pressure, in particular, a liquid pressure. Accordingly, it is conceivable that the flange 50 is not formed of a single material but is formed of two or more materials with separated functions. The description is made with reference to FIG. 14.

### Two Materials of Flange

FIG. 14 is a sectional view showing a modified example where the material of the flanges 50 shown in FIG. 13 is changed, and schematically showing the coupling between the fluid flow paths 22 and the flanges 50. In the example shown in FIG. 13, the flange 50 is formed of one material, such as polypropylene, for example. Preferably, the material is made of the same material as the material of the inner surface of the laminate 24.

In contrast, each flange 50 in FIG. 14 is formed of two materials. Specifically, the flange connection 66 is formed of the two materials. The flange connection 66 has a double-layered structure. A portion corresponding to the inner layer is called an inner flange connection 661. A portion corresponding to the outer layer is called an outer flange connection 662. The inner surface of the inner flange connection 661 faces the flange flow path 67. The laminate 24 is welded to the outer surface of the outer flange connection 662.

The inner flange connection 661 and the outer flange connection 662 are formed of different materials. The inner flange connection 661 is formed of the same material as that of the flange main body 65. The outer flange connection 662 is formed of the same material as that of the inner surface of the laminate 24. Here, the configuration where the material of which the inner flange connection 661 and the flange main body 65 are formed is a high-strength material can secure the strength of the flange 50 while securing the welding strength between the laminate 24 and the flange 50. That is, the two materials are used in different purposes with respect to the functions. The welding strength is secured by one material, and the strength of the entire flange 50 is secured by the other material.

A specific example is as follows. The material of the outer flange connection 662 may be the same as the material of the inner surface of the laminate 24, for example, polypropylene. The material of the inner flange connection 661 and the flange main body 65 may be a material that has a higher strength than the material of the outer flange connection 662 and be, for example, polyphenylene sulfide. Note that the material described above is provided as an example. Improvement in peeling strength can be achieved by a configuration where the laminate welded layer is made of polyethylene terephthalate having a high material strength, and the outer flange connection 662 is also made of the same material, i.e., polyethylene terephthalate. In this case, the inner flange connection 661 may be made of polypropylene. The material may be selected as appropriate depending on the material of the laminate 24 and the function and strength required for the flange 50.

Note that the outer flange connection 662 may be formed by coating the inner flange connection 661 with the material of which the outer flange connection 662 is formed.

In the configuration in FIG. 14, part of the flange 50 is formed of a material that is identical with or similar to the material of the fluid flow path 22. At least part of the portion of the flange 50 that is made of a material that is identical with or similar to the material of the fluid flow path 22 is welded to the fluid flow path 22, thus forming at least part of the weld region 80. That is, the weld region 80 at the flange 50 is formed of a material that is identical with or similar to the material of the fluid flow path 22. At least part of the outer flange connection 662 serves as the weld region 80 at the flange 50. In the configuration shown in FIG. 14, portions of the flange 50 that are other than the weld region 80 may be formed of a material other than the material that is identical with or similar to the material of the fluid flow path 22. Such a same or similar material refers to, for example, a material of the same type.

### Weld Region Support Member

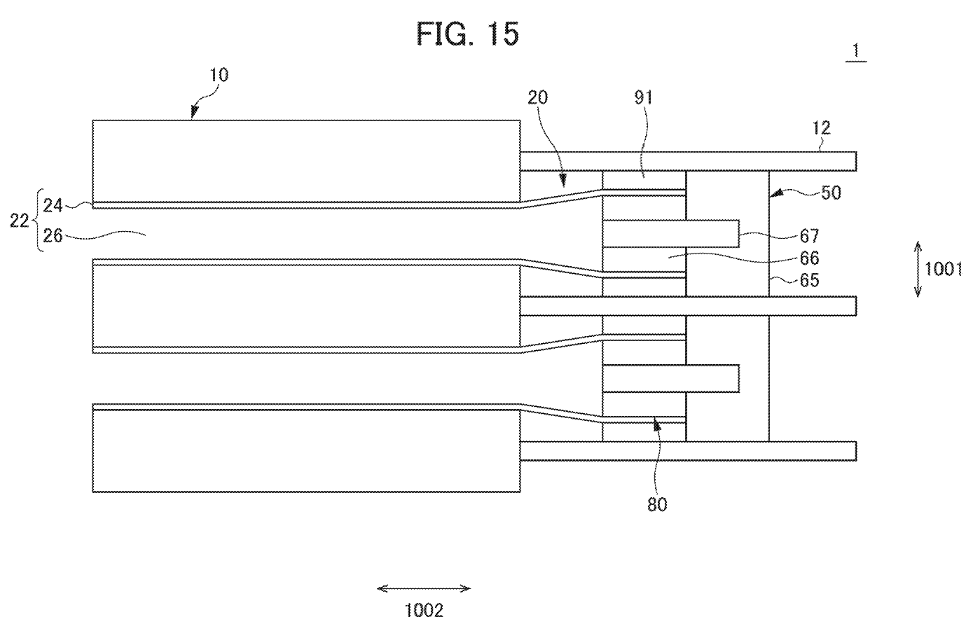

Referring to FIG. 15, the configuration for improving the strength of the weld region 80 is described. FIG. 15 is a sectional view showing a modified example where holders 91 are added to the battery module 1 shown in FIG. 13, and schematically showing the coupling between the fluid flow paths 22 and the flanges 50. The holder 91 is an example of a weld region support member.

The holder 91 (separate cap-shaped member) is provided on the weld region 80 so as to cover the laminate 24. The holder 91 holds the welding between the flange 50 and the fluid flow path 22. That is, the holder 91 reinforces the weld region 80.

The holder 91 may be formed of, for example, resin. The method of forming the holder 91 is not specifically limited.

The holder 91 may be, for example, a preliminarily formed cap-shaped molded object. In the case where the holder 91 is a molded object, before the flange 50 and the fluid flow path 22 are welded together, or after the flange 50 and the fluid flow path 22 are welded together, the holder 91 is disposed at a desired position, thereby allowing the holder 91 to be provided on the weld region 80. In this case, it is preferable that the material of the holder 91 be identical with or similar to the material of the laminate 24 or the flange 50. That is, it is preferable that the material of the holder 91 be identical with or similar to the material of the weld region 80.

Accordingly, against the peel load applied to the weld region 80 due to the internal pressure of the fluid flow path 22, the weld region is physically fixed to the holder 91, which can counteract the peel load, and prevent a peeling force from occurring between the holder 91 and the weld region 80.

When the holder 91 is disposed before welding, at least part of the holder 91 is welded to the laminate 24, which can further improve the strength of the weld region 80.

The holder 91 may be provided on the weld region 80 in the state of uncured resin. In this case, the resin is provided on the weld region 80, and is subsequently cured. The curing method is not specifically limited. For example, UV curing can be used.

Note that the holder 91 may be provided so as to fill the gap between the laminate 24 at the weld region 80 and the cell terminal 12 of the adjacent battery cell 10 in the stack direction 1001. By the holder 91 filling the gap between the laminate 24 and the cell terminal 12, the fluid flow path 22 and the flange 50 can be further prevented from being peeled off.

In the case where the holder 91 is provided on the weld region 80 in the uncured resin state, the holder 91 can easily fill the gap between the laminate 24 and the cell terminal 12. This is because the holder 91 can be formed by filling the gap with the resin in the uncured state and then curing it.

### Weld Region Support Structure

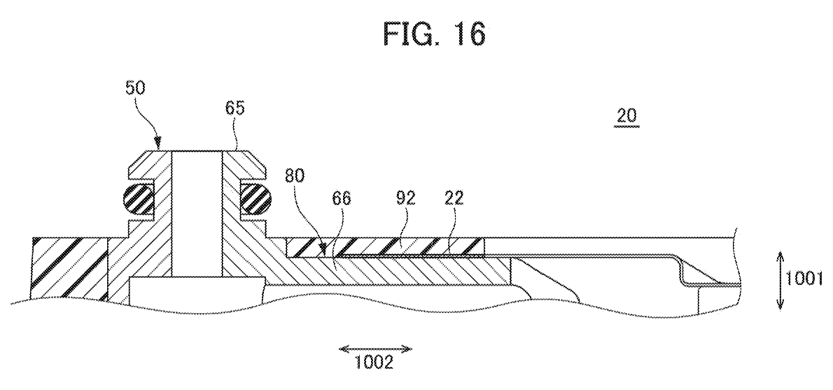

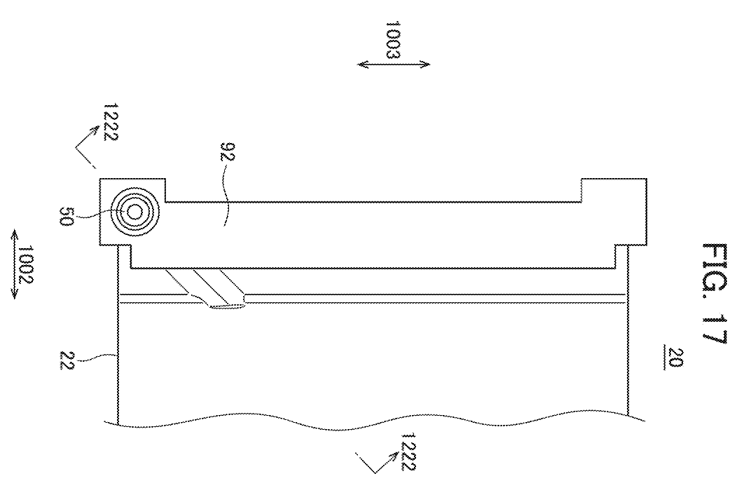

Referring to FIGS. 16 and 17, another configuration for improving the strength of the weld region 80 is described. FIG. 16 is a sectional view where a welding holder 92 (overmolded structure) is added to the battery module 1 shown in FIG. 13. FIG. 17 shows the fluid cushion 20 to which the welding holder 92 is added when viewed from the stack direction 1001. FIG. 16 is a sectional view taken along line 1222-1222 in FIG. 17. The welding holder 92 is an example of a weld region support structure.

The welding holder 92 is a component that covers at least part of the weld region 80 and at least part of the flange 50. The welding holder 92 holds the weld region 80 by covering at least part of the weld region 80, and reinforces the welding between the flange 50 and the fluid flow path 22.

The welding holder 92 is a resin-molded component that has an overmolded structure. Overmolding means wrapping. The welding holder 92 holds the weld region 80 so as to wrap at least part of the weld region 80.

The form of the welding holder 92 is not specifically limited. For example, as shown in FIG. 17, in the case where the flanges 50 are provided at the opposite ends in the width direction 1003 at the ends of the fluid cushions 20 in the fluid path direction 1002, the welding holder 92 may have a form that covers two flanges 50 with one component. Alternatively, unlike the example shown in FIG. 17, the welding holder 92 may have a form that separately covers the two flanges 50.

The welding holder 92 is a component preliminarily molded before being provided for the weld region 80. The welding holder 92 is disposed on the weld region 80 so as to cover at least part of the weld region 80 after the flange 50 and the fluid flow path 22 are welded together. Accordingly, the welding holder 92 reinforces the weld region 80.

The welding holder 92 is preliminarily molded in a desired shape. Accordingly, the welding holder 92 may be disposed so as to be fitted in the flange 50, for example. By molding the welding holder 92 in the shape of being fitted in the flange 50 or the like, the reinforcement of the weld region 80 by the welding holder 92 can be more strengthened.

The material of which the welding holder 92 is made is not specifically limited. For example, the welding holder 92 may be formed of a thermosetting resin or the like.

### Surface Roughness of Flange

As described above, the flange 50 and the fluid flow path 22 are fixed to each other by welding. Preferably, the surface of the flange 50 that is welded to the fluid flow path 22 has a higher surface roughness than other portions of the flange 50. For example, in the previously described configuration shown in FIG. 13, the surface roughness of the external surface of the flange connection 66 is higher than the surface roughness of the surface of the flange main body 65, for example. For example, in the previously described configuration shown in FIG. 14, the external surface of the outer flange connection 662 is roughened to have a higher surface roughness than the surface of the flange main body 65, for example. The roughness of each of the external surface of the flange connection 66 and the external surface of the outer flange connection 662 may be set to, for example, a roughness that is sufficient to prevent breakage under internal pressure.

As described above, the portion of the flange 50 that is welded to the fluid flow path 22 is roughened to have a high surface roughness. Thus, the welding between the flange 50 and the fluid flow path 22 can be strengthened. This is because the contact area between the flange 50 and the fluid flow path 22 can be increased.

Note that the method of increasing the surface roughness is not specifically limited. For example, the surface roughness can be increased by a blasting process or the like.

### Flange Holder

Referring to FIG. 13, the flange holder 5 is described. FIG. 13 shows a flange-side end 101 of the battery cell 10. The flange-side end 101 is an end of the battery cells 10 that faces the flange 50 in the fluid path direction 1002. FIG. 13 shows a cell-side end 501 of the flange 50. The cell-side end 501 is an end of the flange 50 that faces the battery cell 10 in the fluid path direction 1002. The portion between the flange-side end 101 and the cell-side end 501 in the fluid path direction 1002 is called the flange holder 5. The flange holder 5 is a portion that is continuous to the weld region 80 in the fluid flow path 22, and is not in contact with the battery cell 10. The length of the flange holder 5 in the fluid path direction 1002 is called a clearance 1401.

Preferably, the clearance 1401 has an appropriate length, in particular, is short as much as possible. By reducing the length of the clearance 1401, the strength of the fluid flow path 22 at the flange holder 5 can be easily secured. Here, reducing the length refers to, for example, making the clearance 1401 have a length that is sufficient to prevent breakage under internal pressure.

In the fluid path, an internal pressure 1331 occurs. At the flange holder 5, outside of the laminate 24 in the stack direction 1001, there is not a portion, such as of the battery cell 10, in contact with the laminate 24 of the battery cell 10. Consequently, if the clearance 1401 is long, the laminate 24 cannot withstand the internal pressure 1331, and is broken in some cases. Accordingly, the clearance 1401 is optimized to be minimal by adjusting the shape of the flange 50. By optimizing the clearance 1401 to be minimal, the strength of the fluid flow path 22 at the flange holder 5 can be easily secured.

### Flow Rate Control

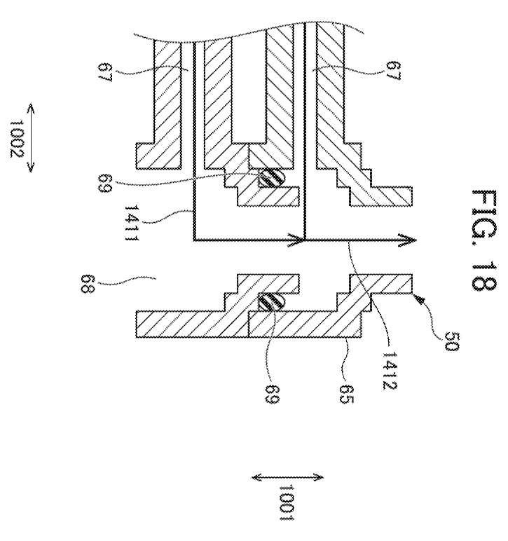

Referring to FIG. 18, the flow of the fluid at the end of the battery module in the fluid path direction 1002 is described. FIG. 18 shows an example of a manner that the flanges 50 are stacked at the end of the battery module in the fluid path direction 1002.

The flanges 50 are staked in the stack direction 1001 at the end of the battery module. In the stacked flanges 50, an end fluid path 68 is formed. The end fluid path 68 is formed by allowing the fluid paths in the flanges 50 to communicate with each other in the stacked flanges 50. The fluid having flown through the flange flow paths 67 of the flanges 50 flows into the end fluid path 68.

FIG. 18 shows a pre-confluence direction 1411 and a post-confluence direction 1412. The pre-confluence direction 1411 is the direction in which the fluid flows through each flange flow path 67. The post-confluence direction 1412 is the direction in which the fluid flows through the end fluid path 68. In the example shown in FIG. 18, the end fluid path 68 extends along the stack direction 1001. The post-confluence direction 1412 extends in a direction that intersects the directions in which the respective flange flow paths 67 extend.

Note that the pre-confluence direction 1411 and the post-confluence direction 1412 in FIG. 18 indicate the flow of the fluid when the fluid flows out of the fluid cushion. When the fluid flows into the fluid cushion, the directions in which the fluid flows are the direction opposite to the directions indicated by the pre-confluence direction 1411 and the post-confluence direction 1412.

Note that when the flanges 50 are stacked, an O-ring 69 may be disposed between the flange 50 and the flange 50.

### Power Unit

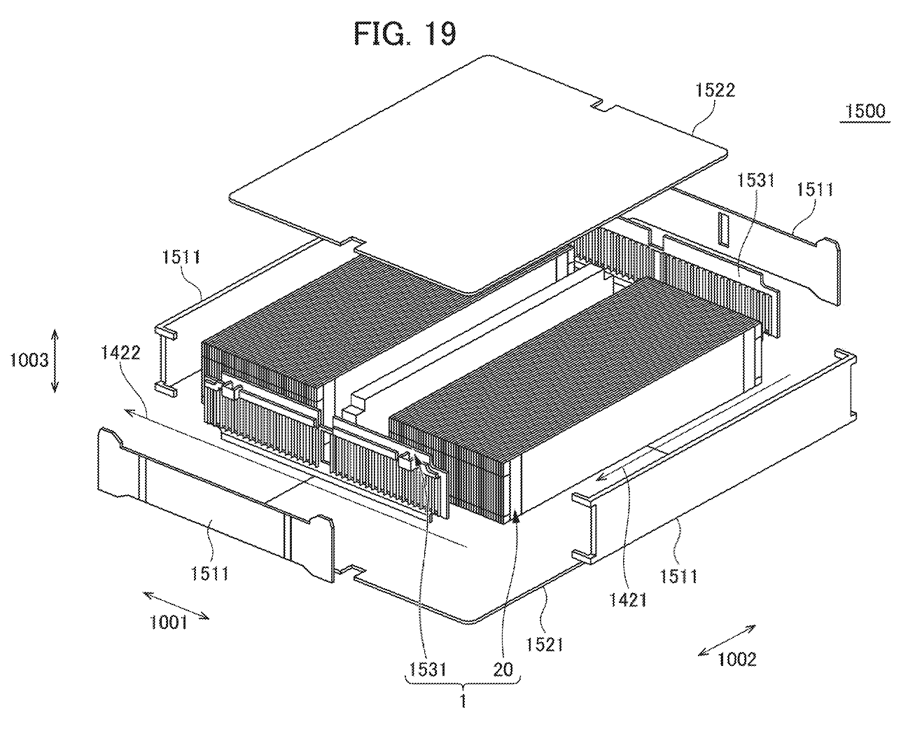

FIG. 19 is an exploded perspective view of a power unit 1500 showing an example of the power unit 1500 in which the battery modules 1 are embedded. In the example shown in FIG. 19, the power unit 1500 includes two battery modules 1. The battery modules 1 are clamped by plate members from on the opposite sides in the stack direction 1001, the fluid path direction 1002, and the width direction 1003, and are fixed, thus forming the power unit 1500.

The four side plate members 1511 shown in FIG. 19 are members that clamp the battery modules 1 in the stack direction 1001 and the fluid path direction 1002. A bottom plate member 1521 and a top plate member 1522 are members that clamp the battery modules 1 in the width direction 1003. The bottom plate member 1521 is in contact with a water jacket (not shown) as a cooling circuit positioned on the bottom surface of the bottom plate member 1521. The cooling circuit is a member that cools the battery modules 1 and the like. The bottom plate member 1521 is disposed opposite to the top plate member 1522, and functions as a bottom plate member.

In FIG. 19, the flanges 50 are drawn in a simplified manner in a state where the plurality of the flanges 50 are stacked.

FIG. 19 shows a back inner flow direction 1421 and a module end flow direction 1422. The back inner flow direction 1421 is a direction in which the fluid flows in the fluid flow path 22. The module end flow direction 1422 is a direction in which the fluid flows at an end of each battery module 1, for example, through a cushion connector 1531. The back inner flow direction 1421 is a direction along the fluid path direction 1002. The module end flow direction 1422 is a direction along the stack direction 1001. The back inner flow direction 1421 in FIG. 19 corresponds to the pre-confluence direction 1411 in FIG. 18. The module end flow direction 1422 in FIG. 19 corresponds to the post-confluence direction 1412 in FIG. 18.

### Relationship With Vehicle Body

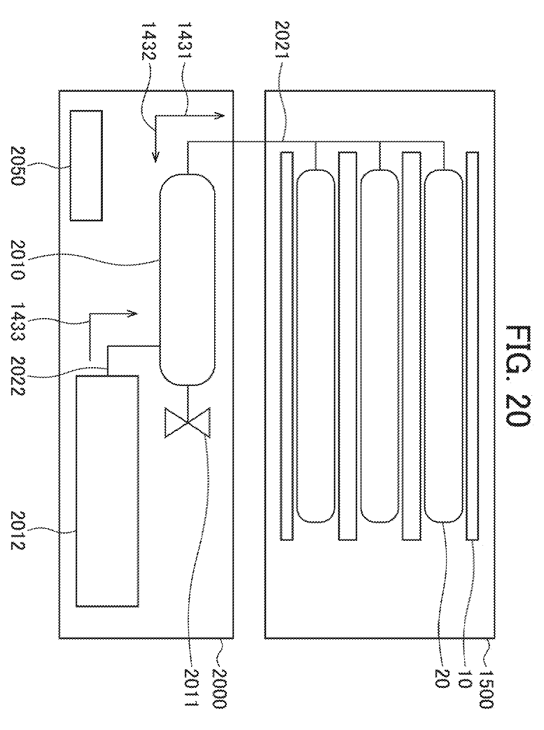

Referring to FIG. 20, the cooperation between the power unit 1500 and a fluid tank 2010 and the like provided for the vehicle body 2000 is described. FIG. 20 shows the flow of fluid between the power unit 1500 and the vehicle body 2000. As shown in FIG. 20, the vehicle body 2000 includes the fluid tank 2010, a safety relief valve 2011, a compressor 2012, and a controller 2050.

The fluid tank 2010 is a tank that stores the fluid that is to flow through the fluid cushions 20. The fluid is any type of gas and liquid. In the case where the fluid is gas, the fluid tank 2010 is called a gas tank. In the case where the gas is air, the gas tank is called an air tank. In the case where the fluid is liquid, the fluid tank 2010 is called a liquid tank. The fluid tank 2010 is coupled to each fluid cushion 20 through a tank line 2021.

The safety relief valve 2011 is, for example, a relief valve for reducing the internal pressure in case the internal pressure of the fluid tank 2010 rises to a dangerous value. The safety relief valve 2011 is provided for the fluid tank 2010.

The compressor 2012, i.e., a compression machine, is a device for increasing the internal pressure in the fluid tank 2010. In the case where the fluid is liquid, the compressor 2012 is configured as a water pump. The compressor 2012 is coupled to the fluid tank 2010 via a compressor line 2022.

The controller 2050 is a portion that controls each component included in the vehicle body 2000. The controller 2050 may determine the state of charge of each battery cell 10.

A detection result is input from, for example, a detection device, such as a sensor, to the controller 2050. The controller 2050 controls the operations of various portions that include components such as the compressor 2012, and valves and the like provided for lines that couple the portions.

FIG. 20 indicates a cushion inflow direction 1431 and a cushion outflow direction 1432. The cushion inflow direction 1431 is a direction in which the fluid flows from the fluid tank 2010 toward each fluid cushion 20. The cushion outflow direction 1432 is a direction in which the fluid flows from each fluid cushion 20 toward the fluid tank 2010.

For example, when the battery cells 10 are charged, and the volumes of the battery cells 10 increase, the fluid flows from the fluid cushions 20 toward the fluid tank 2010 to reduce the volumes of the fluid cushions 20. That is, the fluid flows in the cushion outflow direction 1432.

In contrast, when the battery cells 10 are discharged, and the volumes of the battery cells 10 decrease, the fluid flows from the fluid tank 2010 toward the fluid cushions 20 to increase the volumes of the fluid cushions 20. That is, the fluid flows in the cushion inflow direction 1431.

FIG. 20 shows a tank pressurization direction 1433. The tank pressurization direction 1433 indicates that the operation of the compressor 2012 applies pressure to the fluid in the fluid tank 2010 via the compressor line 2022. Note that as described above, in the case where the fluid is liquid, the compressor 2012 is configured as a water pump. In the case where the fluid is liquid, the tank pressurization direction 1433 indicates that pressure is applied to the fluid in the fluid tank 2010 by the water pump.

Even when the operation of the compressor 2012 expands or contracts the battery cells 10, and the fluid cushions 20 expand or contract accordingly, the internal pressure in each fluid cushion 20 can be easily maintained at a uniform pressure, for example. The compressor 2012 may operate so as to maintain the internal pressure in the fluid tank 2010 at a uniform pressure.

### State of Charge of Battery Cell

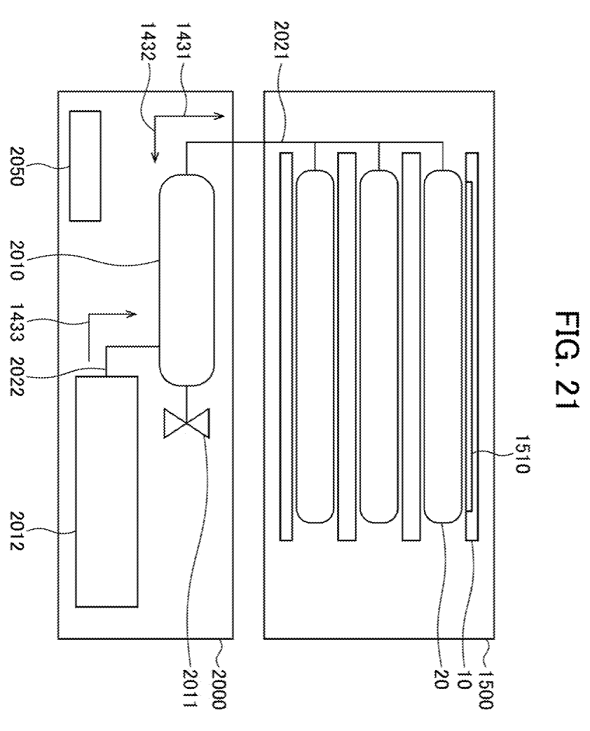

Referring to FIG. 21, the detection of the state of charge (SOC) of the battery cells 10 is described. FIG. 21 shows a power unit 1500 where the power unit 1500 shown in FIG. 20 is further provided with a pressure-sensitive sensor 1510. As described above, the volume of each battery cell 10 changes depending on the charge and discharge state of the battery cell 10. When the volume of the battery cell 10 changes, the pressure between the battery cell 10 and the fluid cushion 20 changes. Typically, when the volume of the battery cell 10 increases, the pressure between the battery cell 10 and the fluid cushion 20 increases. In contrast, when the volume of the battery cell 10 decreases, the pressure between the battery cell 10 and the fluid cushion 20 decreases. Accordingly, the pressure-sensitive sensor 1510 is provided between the battery cell 10 and the corresponding fluid cushion 20. The controller 2050 and the like can determine the state of charge of the battery cell 10 by the pressure detected by the pressure-sensitive sensor 1510.

Note that in the example shown in FIG. 21, one pressure-sensitive sensor 1510 is provided for the power unit 1500. However, the number of pressure-sensitive sensors 1510 provided for the power unit 1500 is not limited to one. A plurality of pressure-sensitive sensors 1510 may be provided between, for example, the battery cells 10 and the fluid cushions 20. A plurality of pressure-sensitive sensors 1510 may be provided between the battery cells 10 and the fluid cushions 20 at different positions in at least one selected from the fluid path direction 1002 and the width direction 1003.

Based on the pressure detected by the pressure-sensitive sensor 1510, the state of charge of the battery cells 10 can be identified. Based on the detected pressure, the exchange of the fluid between the fluid cushions 20 and the fluid tank 2010 can be controlled. Based on the detected pressure, the operation of the compressor 2012 can be controlled.

### State of Fluid Tank

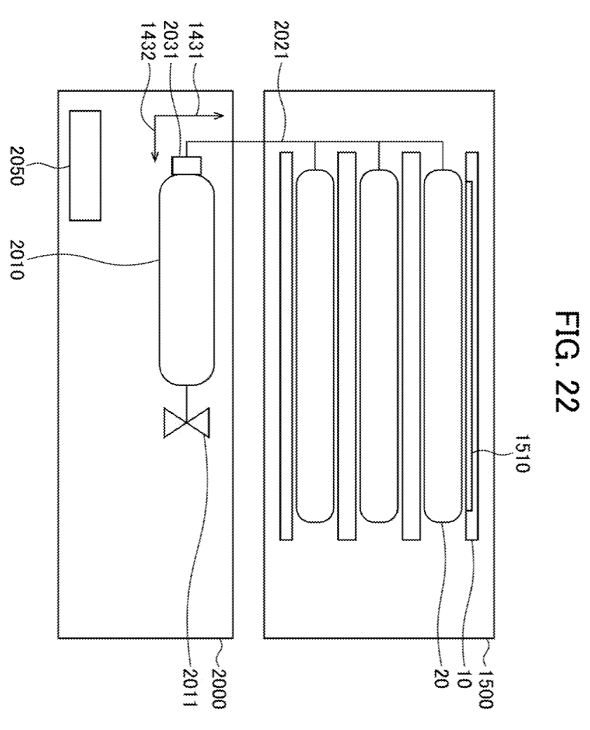

Referring to FIG. 22, the detection of the state of charge of the battery cells 10 via the fluid tank 2010 is described. FIG. 22 shows a vehicle body 2000 where the vehicle body 2000 shown in FIG. 21 is further provided with a tank sensor 2031. The tank sensor 2031 may be a sensor that detects the volume in the fluid tank 2010, for example.

The volume in the fluid tank 2010 changes depending on the charge and discharge state of the battery cells 10. As described above, when the battery cells 10 are charged, a flow in the cushion outflow direction 1432 occurs in the tank line 2021. As a result, the volume in the fluid tank 2010 increases. In contrast, when the battery cells 10 are discharged, a flow in the cushion inflow direction 1431 occurs in the tank line 2021. As a result, the volume in the fluid tank 2010 decreases.

The tank sensor 2031 detects the volume in the fluid tank 2010. That is, the tank sensor 2031 detects at least one selected from the expansion and the contraction of the fluid tank 2010. In particular, in a case where no compressor 2012 is provided, a case where the compressor 2012 does not operate, and other such cases, the state of charge of the battery cells 10 can be determined based on the volume in the fluid tank 2010 that is detected by the tank sensor 2031.

In addition to the detection result of the pressure-sensitive sensor 1510, the detection result of the tank sensor 2031 is combined, and the state of charge of the battery cells 10 is determined, which can more correctly determine the state of charge.

Note that in the case where the tank sensor 2031 is provided, the pressure-sensitive sensor 1510 does not necessarily need to be provided. This is because the state of charge of the battery cells 10 can be determined based only on the detection result of the tank sensor 2031.

The tank sensor 2031 is not limited to the sensor that detects the change in volume in the fluid tank 2010. For example, the tank sensor 2031 may be configured to detect the internal pressure of the fluid tank 2010 or the directional sense of the fluid flowing through the tank line 2021. The state of charge of the battery cells 10 can be determined also based on the internal pressure of the fluid tank 2010, the directional sense of the fluid in the tank line 2021 and the like.

In the case of detecting the directional sense of the fluid flowing in the tank line 2021, a device for sensing may be provided on the tank line 2021. That is, a device that detects the directional sense of the fluid flowing in the tank line 2021 does not necessarily need to be provided for the fluid tank 2010.

### Water Jacket

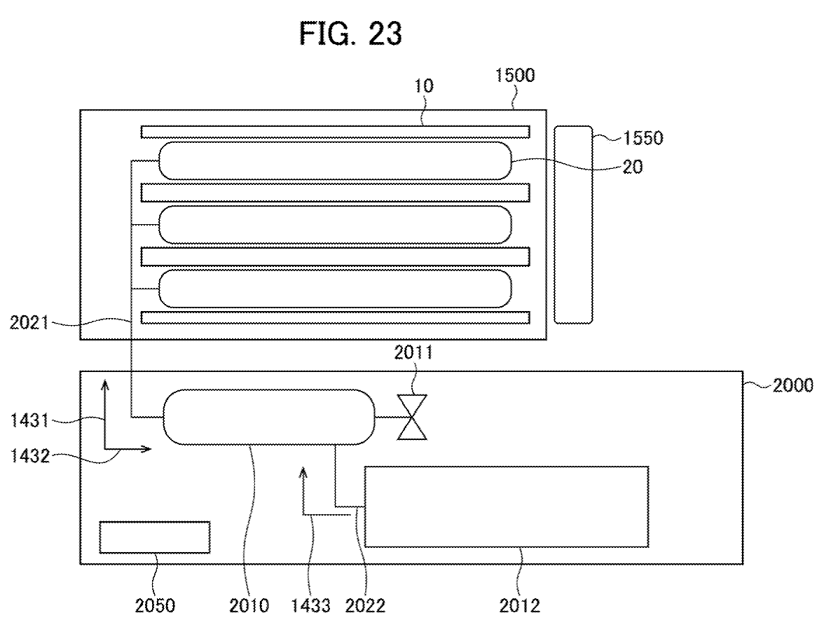

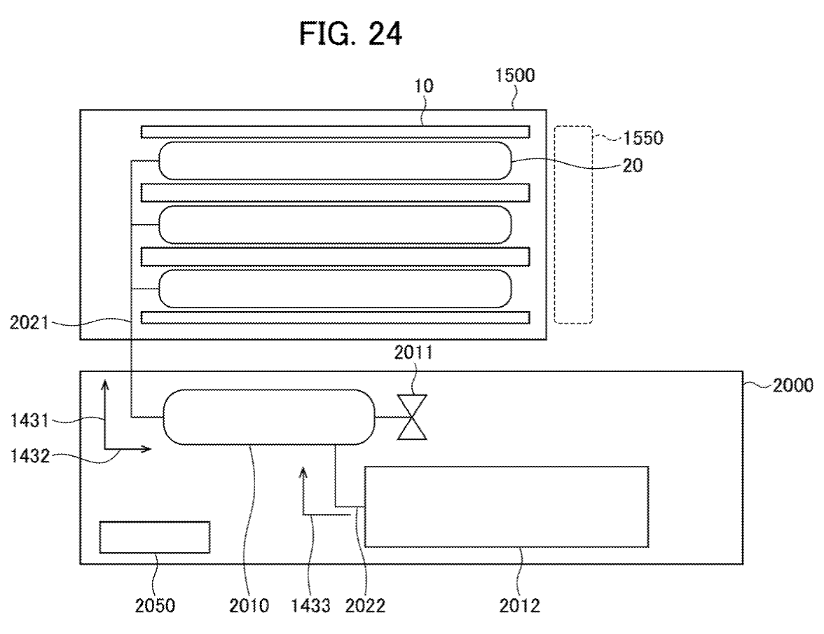

Referring to FIGS. 23 and 24, a water jacket 1550 is described. FIG. 23 shows a power unit 1500 where the power unit 1500 shown in FIG. 20 is further provided with the water jacket 1550. FIG. 24 shows a power unit 1500 where the water jacket 1550 is omitted from the power unit 1500 shown in FIG. 23.

As described above with reference to FIG. 19, the water jacket 1550 is provided for cooling the battery cells 10 and the like. The water jacket 1550 is disposed to be branched from the cooling flow path of the vehicle, for example. Accordingly, the water jacket 1550 can serve as part of the cooling system of the vehicle, and cool the battery cells 10. The cooling system of the vehicle is described later.

Incidentally, the battery module 1 in the present embodiment includes the fluid cushions 20. The fluid flows in the fluid cushions 20. Here, in the case where the fluid is liquid, the fluid cushions 20 can perform at least part of the function of the water jacket 1550. The fluid cushions 20 can not only alleviate the change in volume of the battery cells 10 but also cool the battery cells 10. Accordingly, the load on the cooling system of the vehicle can be reduced.

By the fluid cushions 20 performing at least part of the function of the water jacket 1550, the water jacket 1550 may be omitted as shown in FIG. 24.

### Cooling System of Vehicle

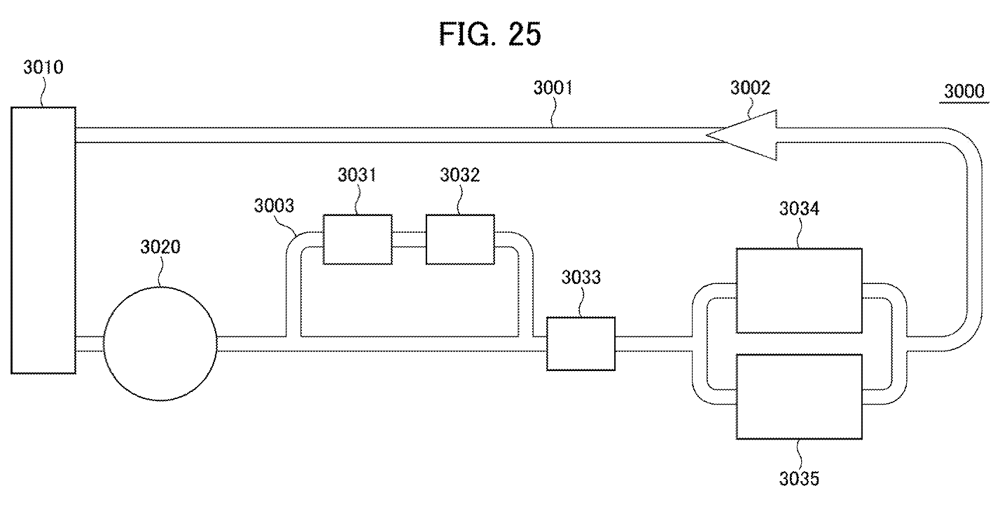

Referring to FIG. 25, a cooling system 3000 of the vehicle is described. FIG. 25 schematically shows an example of the cooling system 3000 of the vehicle. The cooling system 3000 includes a vehicle cooling flow path 3001, a radiator 3010, and a water pump 3020. The vehicle cooling flow path 3001 is a fluid path through which liquid for cooling flows. FIG. 25 shows a fluid path flow direction 3002. The fluid path flow direction 3002 is a direction in which the fluid flows through the vehicle cooling flow path 3001.

A cooling target device is coupled to the vehicle cooling flow path 3001. The cooling target device is a device that is cooled by the liquid flowing through the vehicle cooling flow path 3001. FIG. 25 shows, as an example, five cooling target devices that are a first cooling target device 3031, a second cooling target device 3032, a third cooling target device 3033, a fourth cooling target device 3034, and a fifth cooling target device 3035.

Examples of the cooling target devices include a motor, a transmission, and a battery.

The cooling target device is coupled to the vehicle cooling flow path 3001. In other words, the cooling target device branches the vehicle cooling flow path 3001.

The cooling target device is coupled to the vehicle cooling flow path 3001 in any of various forms. Examples of the coupling forms are as follows. The first cooling target device 3031 and the second cooling target device 3032 are coupled to a bypass fluid path 3003 that is a fluid path formed to serve as a bypass from the vehicle cooling flow path 3001. The first cooling target device 3031 and the second cooling target device 3032 are disposed in series on the bypass fluid path 3003.

The third cooling target device 3033 is directly coupled to the vehicle cooling flow path 3001. The fourth cooling target device 3034 and the fifth cooling target device 3035 are coupled to the vehicle cooling flow path 3001 so as to be positioned in parallel. Note that the form of coupling of the cooling target device to the vehicle cooling flow path 3001 is not limited to the example shown in FIG. 25.

A valve may be provided for at least one selected from a portion at which the vehicle cooling flow path 3001 is branched, and a portion on the upstream side of the cooling target device. Adjustment of the valve can adjust the flow rate of the liquid flowing through the vehicle cooling flow path 3001, and in turn, adjust the flow rate of the liquid flowing through the cooling target device.

In the case where the water jacket 1550 is provided for the battery module 1 in the present embodiment, the water jacket 1550 (the cooling circuit on the bottom surface of the plate 1521) serves as the cooling target device and is coupled to the vehicle cooling flow path 3001.

The battery module 1 in the present embodiment may be configured such that the fluid flowing through the vehicle cooling flow path 3001 flows to the fluid cushions 20. Here, the multiple fluid cushions 20, and the corresponding cushion connectors 1531 are collectively called a pressurization structure. The pressurization structure may branch the vehicle cooling flow path 3001. That is, the pressurization structure may be coupled to the vehicle cooling flow path 3001. Accordingly, the liquid in the vehicle cooling flow path 3001 is allowed to flow through the fluid cushions 20.

In the battery module 1 in the present embodiment, the pressurization structure may branch the vehicle cooling flow path 3001 provided with the water jacket 1550. That is, the pressurization structure may be provided on the vehicle cooling flow path 3001 that allows the liquid to flow to the water jacket 1550. For instance, in the example shown in FIG. 25, at least one selected from the first cooling target device 3031 and the second cooling target device 3032 may serve as the pressurization structure, and the remaining one may serve as the water jacket 1550.

The battery module in the present embodiment allows positioning using the four corners of the flange, and facilitates the adjustment of the pressurization range, thus stabilizing the battery performance. By configuring the flow path of the fluid at the corner of the flange, the volumetric energy density of the battery module can be maximized.

In the battery module in the present embodiment, in accordance with the shape of each component positioned around the battery cell and the like, depending on the shape of the flange, the clearance between the portion that is to be pressurized in the battery cell stack, and the portion that fixes each component can be adjusted. As a result, the durability of the fluid cushion, in particular, of the fluid flow path can be improved. The strength of the weld region can be improved by the support member or the support structure.

According to the battery module in the present embodiment, the positioning between the tab lead of the battery cell and the bus-bar of the battery module is facilitated by the flange when the battery cells and the fluid cushions are alternately stacked when the battery cell stack is assembled. Accordingly, the ease of assembly is improved. Stacking with the flange being interposed facilitates assembly using no specific jig for adjusting the height.

The embodiments of the present invention have thus been described above. The present invention is not limited to the embodiments described above, and can be variously changed, modified, or combined.

What is claimed is:

1. A fluid cushion that is disposed between battery cells stacked together in a stack direction, the fluid cushion comprising
a cell positioner configured to position the battery cells, which are adjacent to each other in the stack direction, in at least one direction orthogonal to the stack direction.

2. The fluid cushion according to claim 1, comprising a flange, wherein
the flange includes a concavity having a shape that matches a shape of an end of each of the battery cells as the cell positioner.

3. The fluid cushion according to claim 2, comprising a cooling flow path, wherein
the flange is provided at each of opposite ends of the cooling flow path, and
the flange further includes a weld region at which the flange and the cooling flow path are fixed to each other by welding.

4. The fluid cushion according to claim 3, wherein
the weld region has a strength that can absorb a peel load that occurs between the flange and the cooling flow path.

5. The fluid cushion according to claim 3, wherein
the cooling flow path is constituted of a fluid flow path, and
the weld region of the flange is formed of a material that is identical with or similar to a material of the fluid flow path.

6. The fluid cushion according to claim 3, wherein
a separate cap-shaped member configured to cover the weld region and hold the welding between the flange and the cooling flow path is provided.

7. The fluid cushion according to claim 3, wherein
an overmolded structure configured to cover the weld region and hold the welding between the flange and the cooling flow path is provided.

8. The fluid cushion according to claim 3, wherein
an outer surface of the weld region of the flange has a higher surface roughness than a surface of another portion of the flange.

9. The fluid cushion according to claim 3, wherein
the cooling flow path is configured such that a length of a portion that is continuous with the weld region and is not in contact with the battery cell is short.

10. A battery module, comprising:
the fluid cushion according to claim 1;
battery cells stacked with the fluid cushion interposed therebetween;
a fluid tank that is coupled to the fluid cushion;
a compressor that is coupled to the fluid tank; and
a controller, wherein
the controller controls an operation of the compressor such that depending on at least one of expansion or contraction of the fluid cushion, pressure in the fluid cushion becomes a uniform pressure.
